(19) United States
(12) Patent Application Publication
(10) Pub. No.: US 2024/0323366 A1
(43) Pub. Date: Sep. 26, 2024

(54) METHODS AND APPARATUSES FOR ENCODING/DECODING A VIDEO

(71) Applicant: InterDigital CE Patent Holdings, SAS, Paris (FR)

(72) Inventors: Philippe Bordes, Laille (FR); Ya Chen, Rennes (FR); Thierry Dumas, Rennes (FR); Franck Galpin, Thorigne-Fouillard (FR); Karam Naser, Mouaze (FR); Antoine Robert, Mezieres sur Couesnon (FR)

(21) Appl. No.: 18/278,335

(22) PCT Filed: Feb. 22, 2022
(86) PCT No.: PCT/EP2022/054392

§ 371 Date: Aug. 22, 2023

(30) Foreign Application Priority Data
Feb. 25, 2021 (EP) 21305227.7
May 5, 2021 (EP) 21305578.3

(51) Int. Cl. H04N 19/117; H04N 19/132; H04N 19/172; H04N 19/80

(52) U.S. Cl. CPC H04N 19/117; H04N 19/132; H04N 19/172; H04N 19/80

(57) ABSTRACT

A method for reconstructing at least one part of a first picture, from at least one part of a second picture is provided, said first picture and said second picture having different sizes. The reconstructing comprising decoding said second picture from a bitstream and determining at least one first sample of said at least one part of the first picture using at least one resampling filter applied to at least one second sample of said at least one part of the decoded second picture. A corresponding apparatus for reconstructing at least one part of a first picture is provided. A method for encoding/decoding a video, and corresponding apparatuses, are provided which comprise the reconstructing at least one part of a first picture, from at least one part of a second picture, said first picture and said second picture having different sizes.

### TECHNICAL FIELD

The present embodiments generally relate to a method and an apparatus for video encoding or decoding. Some embodiments relate to methods and apparatuses for video encoding or decoding where original pictures and reconstructed pictures are dynamically re-scaled for encoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an embodiment, a method for reconstructing at least one part of a first picture, from at least one part of a second picture is provided wherein said first picture and said second picture having different sizes, and said reconstructing comprises decoding said second picture from a bitstream, determining at least one first sample of said at least one part of the first picture using at least one resampling filter applied to at least one second sample of said at least one part of the decoded second picture.

According to another embodiment, an apparatus for reconstructing at least one part of a first picture, from at least one part of a second picture is provided, comprising one or more processors, wherein the one or more processors are configured to decode said second picture from a bitstream, determine at least one first sample of said at least one part of the first picture using at least one resampling filter applied to at least one second sample of said at least one part of the decoded second picture, said first picture and said second picture having different sizes.

According to another embodiment, a method of video encoding is provided which comprises encoding a second picture in a bitstream, said second picture being a downscaled picture from a first picture, encoding a third picture in the bitstream, the third picture having a same size as the first picture, wherein encoding the third picture comprises reconstructing at least one part of the first picture by upsampling at least one part of the second picture after decoding, said upsampling comprising determining at least one first sample of said at least one part of the first picture using at least one upsampling filter applied to at least one second sample of said at least one part of the decoded second picture.

According to another embodiment, an apparatus for video encoding is provided, comprising one or more processors, wherein said one or more processors are configured to encode a second picture in a bitstream, said second picture being a downscaled picture from a first picture, encode a third picture in the bitstream, the third picture having a same size as the first picture, wherein encoding the third picture comprises reconstructing at least one part of the first picture by upsampling at least one part of the second picture after decoding, said upsampling comprising determining at least one first sample of said at least one part of the first picture using at least one upsampling filter applied to at least one second sample of said at least one part of the decoded second picture.

According to another embodiment, a method of video decoding is provided which comprises decoding a second picture in a bitstream, said second picture being a downscaled picture from a first picture, decoding a third picture in the bitstream, the third picture having a same size as the first picture, wherein decoding the third picture comprises reconstructing at least one part of the first picture by upsampling at least one part of the second picture after decoding, said upsampling comprising determining at least one first sample of said at least one part of the first picture using at least one upsampling filter applied to at least one second sample of said at least one part of the decoded second picture.

According to another embodiment, an apparatus for video decoding is provided, comprising one or more processors, wherein said one or more processors are configured to decode a second picture in a bitstream, said second picture being a downscaled picture from a first picture, decode a third picture in the bitstream, the third picture having a same size as the first picture, wherein decoding the third picture comprises reconstructing at least one part of the first picture by upsampling at least one part of the second picture after decoding, said upsampling comprising determining at least one first sample of said at least one part of the first picture using at least one upsampling filter applied to at least one second sample of said at least one part of the decoded second picture.

In a variant, the method for encoding/decoding a video comprises storing said at least one reconstructed part of the first picture in a decoded picture buffer storing reference pictures for coding the third picture.

According to another aspect, a method for encoding a video is provided, wherein encoding the video comprises classifying samples of a first picture, determining, for at least one part of the first picture, a first filter based on said classification, said first filter being used for a first encoding operation using said at least one part of the first picture, providing a first modified part of the first picture, determining a second filter based on said classification, said second filter being used for a second encoding operation using said first modified part of the first picture.

An apparatus for encoding a video is provided. The apparatus comprises one or more processors, wherein said one or more processors are configured to encode a video by classifying samples of a first picture, determining, for at least one part of the first picture, a first filter based on said classification, said first filter being used for a first encoding operation using said at least one part of the first picture, providing a first modified part of the first picture, determining a second filter based on said classification, said second filter being used for a second encoding operation using said first modified part of the first picture.

According to another aspect, a method for decoding a video is provided, wherein decoding the video comprises classifying samples of a first picture, determining, for at least one part of the first picture, a first filter based on said classification, said first filter being used for a first decoding operation using said at least one part of the first picture, providing a first modified part of the first picture, determining a second filter based on said classification, said second filter being used for a second decoding operation using said first modified part of the first picture.

An apparatus for decoding a video is provided. The apparatus comprises one or more processors, wherein said one or more processors are configured to decode a video, wherein decoding the video comprises classifying samples of a first picture, determining, for at least one part of the first picture, a first filter based on said classification, said first filter being used for a first decoding operation using said at least one part of the first picture, providing a first modified part of the first picture, determining a second filter based on said classification, said second filter being used for a second decoding operation using said first modified part of the first picture.

According to an embodiment of any one of the aspects cited above, the classification is stored in a decoded picture buffer storing reference pictures, i.e. index associated with each sample of the first picture are stored in the decoded picture buffer.

According to another aspect, another method for encoding a video is provided, wherein encoding the video comprises classifying samples of a reference picture, and for at least one block of the video, determining at least one part of the reference picture, using at least one motion vector of the at least one block, determining, for the at least one part of the reference picture, at least one interpolation filter based on said classification, determining a prediction for said block, based on a filtering of said at least one part of the reference picture using said at least one interpolation filter determined, encoding said block based on said prediction.

An apparatus for encoding a video is provided, the apparatus comprising one or more processors, configured to encode the video, by classifying samples of a reference picture, and for at least one block of the video: determining at least one part of the reference picture, using at least one motion vector of the at least one block, determining, for the at least one part of the reference picture, at least one interpolation filter based on said classification, determining a prediction for said block, based on a filtering of said at least one part of the reference picture using said at least one interpolation filter determined, encoding said block based on said prediction.

According to another aspect, another method for decoding a video that comprises classifying samples of a reference picture, and for at least one block of the video: determining at least one part of the reference picture, using at least one motion vector of the at least one block, determining, for the at least one part of the reference picture, at least one interpolation filter based on said classification, determining a prediction for said block, based on a filtering of said at least one part of the reference picture using said at least one interpolation filter determined, decoding said block based on said prediction.

An apparatus for decoding a video is provided, the apparatus comprising one or more processors, configured to decode the video by classifying samples of a reference picture, and for at least one block of the video: determining at least one part of the reference picture, using at least one motion vector of the at least one block, determining, for the at least one part of the reference picture, at least one interpolation filter based on said classification, determining a prediction for said block, based on a filtering of said at least one part of the reference picture using said at least one interpolation filter determined, decoding said block based on said prediction.

One or more embodiments also provide a computer program comprising instructions which when executed by one or more processors cause the one or more processors to perform the reconstructing method, or encoding method or decoding method according to any of the embodiments described herein. One or more of the present embodiments also provide a computer readable storage medium having stored thereon instructions for reconstructed a part of a picture, encoding or decoding video data according to the methods described above. One or more embodiments also provide a computer readable storage medium having stored thereon a bitstream generated according to the methods described above. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates an exemplary method for encoding a video according to an embodiment.

FIG. 5 illustrates an exemplary method for reconstructing a video according to an embodiment.

FIG. 6 illustrates an example of motion compensation of a current block in a current picture in a reference picture when the reference picture has a different resolution than the current picture, according to an embodiment.

FIG. 7 illustrates an example of determination of filter coefficients values as a function of a phase of a sample, according to an embodiment.

FIG. 8 illustrates an example of a two stages motion compensation filtering, according to an embodiment.

FIG. 9 illustrates an example of horizontal filtering in a first stage of a motion compensation filtering, according to an embodiment.

FIG. 10 illustrates an example of vertical filtering in a second stage of a motion compensation filtering, according to an embodiment.

FIG. 11 illustrates examples of symmetrical filter and filter rotation.

FIG. 12 illustrates an example of a method for determining an upsampling filer according to an embodiment.

FIG. 13 illustrates an example of a method for encoding/decoding a picture according to an embodiment.

FIG. 14A illustrates an example of different phases corresponding to an upsampling by two in a horizontal and vertical directions, according to an embodiment.

FIG. 14B-I illustrate examples of different shapes for the upsamling filter, according to embodiments.

FIG. 15 illustrates an example of a method for determining upsampling filters coefficients according to an embodiment.

FIG. 16 illustrates an example of a method for encoding a video according to an embodiment.

FIG. 17 illustrates an example of a method for decoding a video according to an embodiment.

FIG. 18 illustrates an example of a method for encoding/decoding a video according to an embodiment,

FIG. 19 illustrates an example of a method for encoding/decoding a video according to another embodiment,

FIG. 20 illustrates an example of a method for encoding/decoding a video according to another embodiment,

FIG. 21 illustrates an example of a method for decoding a video according to another embodiment.

FIG. 22 shows two remote devices communicating over a communication network in accordance with an example of the present principles.

FIG. 23 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

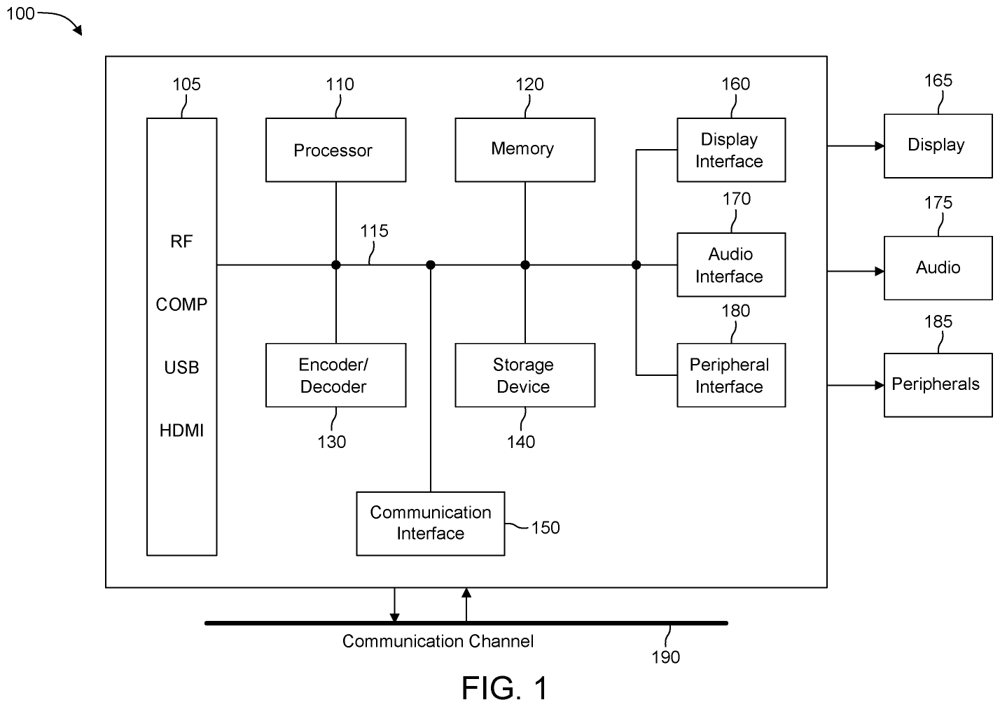

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

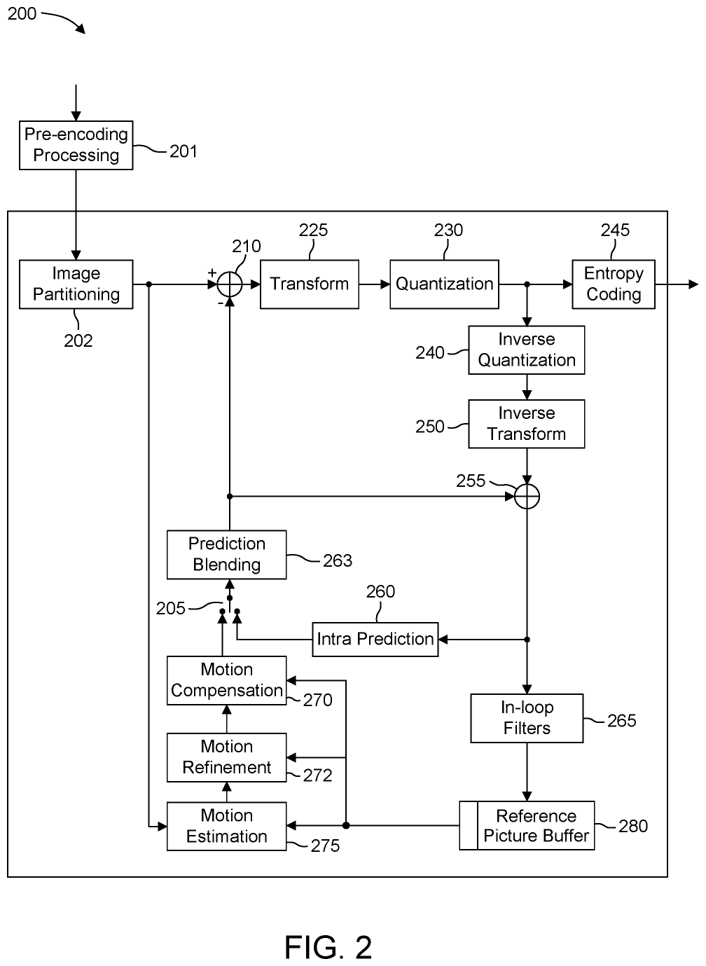

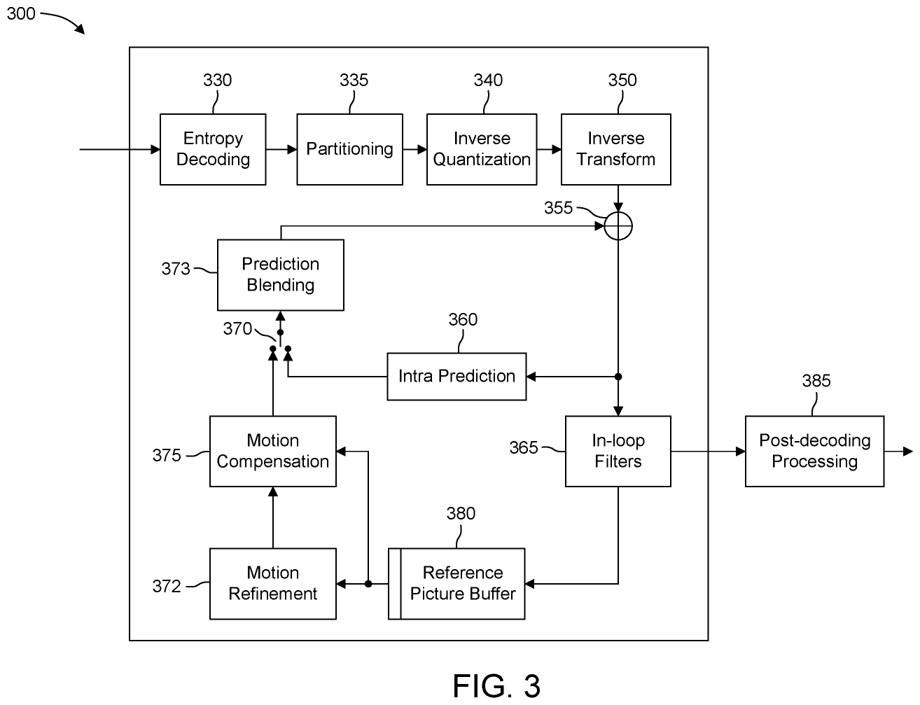

Various methods and other aspects described in this application can be used to modify modules, for example, the motion compensation module (270, 375), of a video encoder 200 and decoder 300 as shown in FIG. 2 and FIG. 3. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

FIG. 2 illustrates an encoder 200. Variations of this encoder 200 are contemplated, but the encoder 200 is described below for purposes of clarity without describing all expected variations.

In some embodiments, FIG. 2 also illustrate an encoder in which improvements are made to the HEVC standard or an encoder employing technologies similar to HEVC, such as a VVC (Versatile Video Coding) encoder under development by JVET (Joint Video Exploration Team).

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

### Reference Picture Re-sampling

At low bitrate and/or when the pictures have few high frequencies, for better coding efficiency trade-off, down-sized pictures can be encoded rather than full resolution, in case of 4K or 8K frames typically. In charge to the decoder to up-scale the decoded pictures before display. The principle of Reference Picture Re-sampling (RPR) is to dynamically re-scale the images of the video sequence at picture basis for the sake of better coding efficiency trade-off.

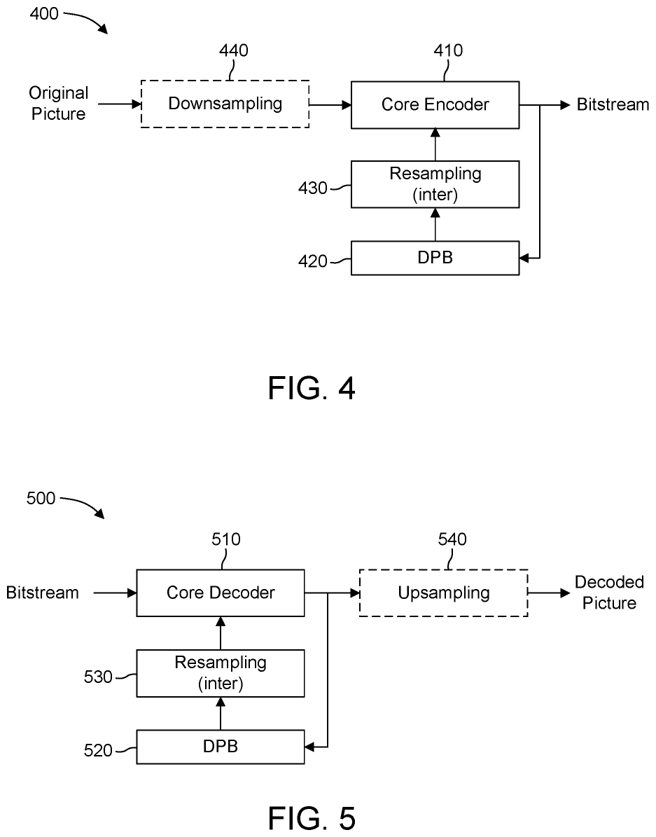

FIGS. 4 and 5 illustrate examples of methods for encoding (400) and decoding (500), respectively, a video according to an embodiment wherein an image to encode can be re-scaled for encoding. For instance, such encoder and decoder can be compliant with the VVC standard.

Given an original video sequence composed of pictures of size (picWidth×picHeight), the encoder chooses for each original picture a resolution (i.e. picture size) for coding the frame. Different PPS (for Picture Parameter Set) are coded in the bit-stream with the size of the pictures and the slice/picture header of a picture to decode indicates which PPS to use on the decoder side to decode the picture.

The down-sampler (440) and the up-sampler (540) functions used as pre- or post-processing respectively are not specified by the standard.

For each frame, the encoder chooses whether to encode at original or down-sized resolution (ex: picture width/height divided by 2). The choice can be made with two passes encoding or considering spatial and temporal activity in the original pictures.

When the encoder chooses to encode an original picture at a down-sized resolution, the original picture is downscaled (440) before being input to the core encoder (410) to produce a bitstream. The reconstructed picture at the downscaled resolution is then stored (420) in the decoded picture buffer (DPB) for coding subsequent pictures. Consequently, the decoded picture buffer (DPB) can contain pictures with different size as the current picture size.

At the decoder, the picture is decoded (510) from the bitstream and the reconstructed picture at the downscaled resolution is stored (520) in the decoded picture buffer (DPB) for decoding subsequent pictures. According to an embodiment, the reconstructed picture is upsampled (540) to its original resolution and for instance transmitted to a display.

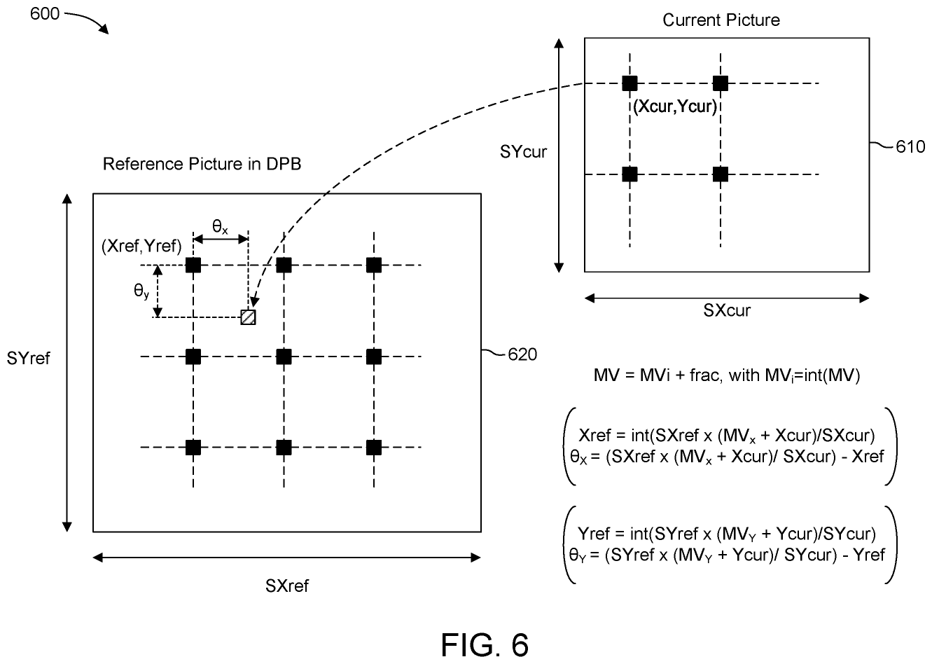

According to an embodiment, in case a current picture to be encoded uses a reference picture from the DPB that has size different from the current picture, a re-scaling (430/530) (up-scale or down-scale) of the reference block to build the prediction block is made (on-the-fly) during the motion compensation process with separable (horizontal and vertical) interpolation filters and appropriate sampling. FIG. 6 illustrates an example of motion compensation with an implicit block re-sampling that can be implemented in the re-scaling (430/530) of the encoding method and decoding method discussed above. The selection of the filter coefficients depends on the phase (θₓ, θ_{y}) (position of the sample to interpolate in the reference picture) which depends both on the motion vector and both the size of reference picture (620 in FIG. 6) (SXref, SYref) and current picture (610 in FIG. 6) (SXcur,SYcur) in this case (eq.1)(FIG. 6).

To predict a current block prediction P (610) of size (SXcur, SYcur), for each sample Xcur of P its position (Xref, Yref) in the reference picture is determined. The values of (Xref, Yref) are function of the motion vector (MVx,MVy) of the current block and of the scaling ratio between the current block size and the corresponding region in the reference picture (SXref, SYref) (620).

Let's denote (⊖x, ⊖y) the phase that is the non-integer part of the motion compensated point (Xref, Yref) in the reference picture, as depicted in FIG. 6. The positions (Xref, Yref) and the phases (⊖x, ⊖y) are given by the following equations:

$$Xref = int ( SXref \times ( {MV}_{X} + Xcur ) / SXcur ) \qquad ( eq . 1 )$$

$$Yref = int ( SYref \times ( {MV}_{Y} + Ycur ) / SYcur )$$

$${⊖}_{x} = ( SXref \times ( {MV}_{X} + Xcur ) / SXcur ) - Xref$$

$${⊖}_{y} = ( SYref \times ( {MV}_{Y} + Ycur ) / SYcur ) - Yref$$

With int(x) giving the integer part of x.

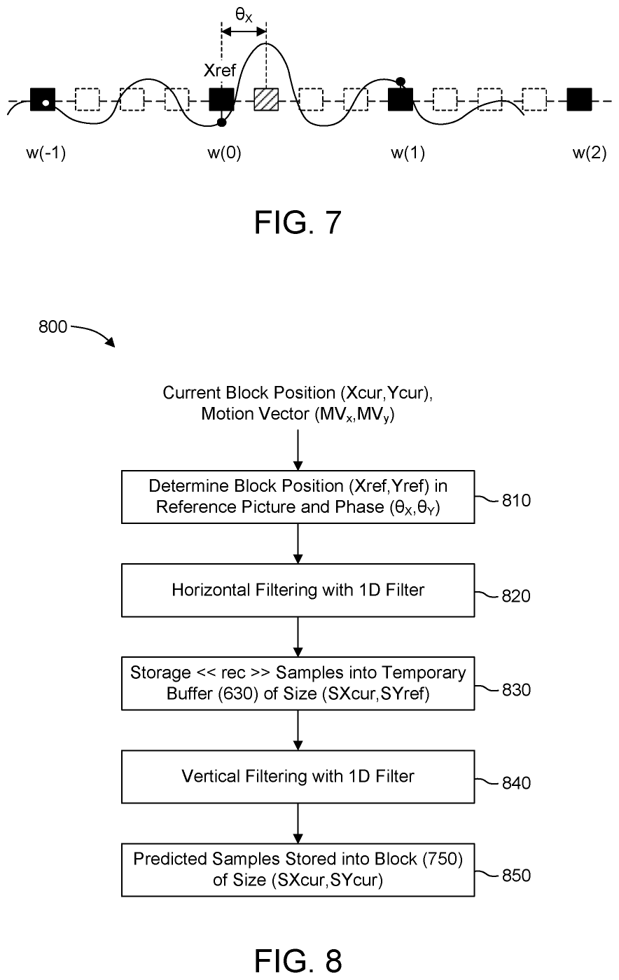

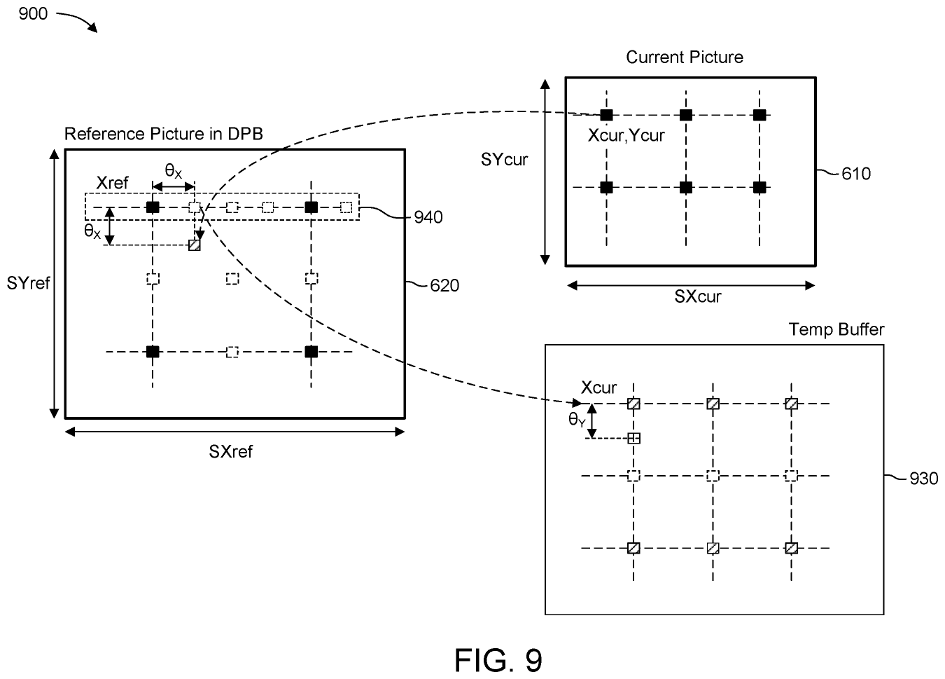

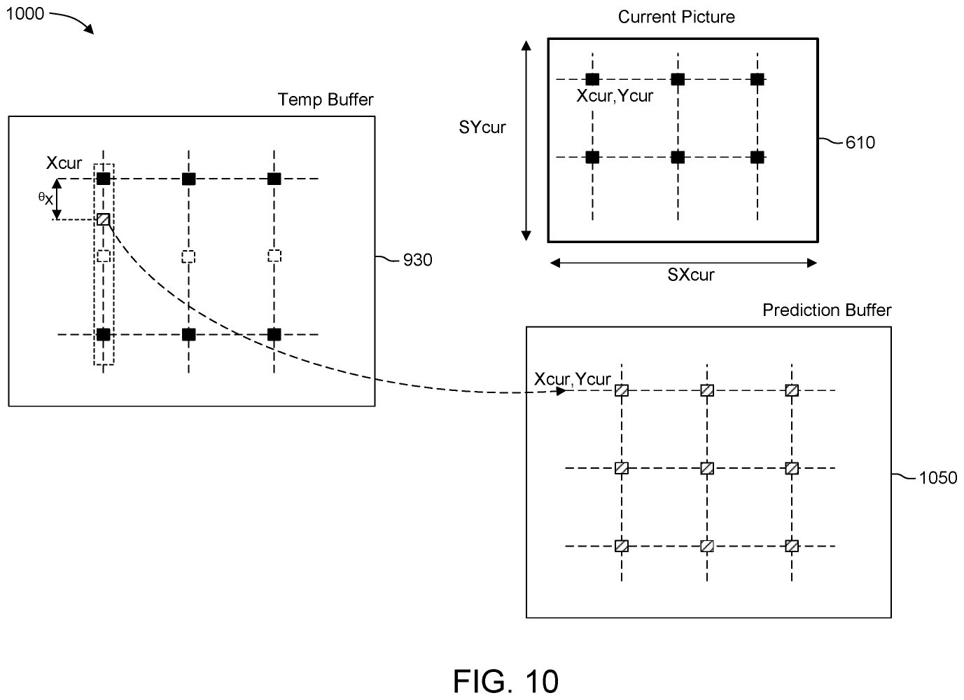

In an embodiment, the motion compensation (MC) uses two separate 1D filters to reduce the amount of calculations (FIG. 7). The MC process is performed in two stages as depicted in FIG. 8, FIG. 9 and FIG. 10: first horizontal (820, 900) and next vertical (840, 1000) motion compensation filtering, or in a variant, vertical motion compensation filtering can be performed first and horizontal motion compensation filtering next.

FIG. 8 illustrates an example of a two stages motion compensation filtering, according to an embodiment. The block position (Xref, Yref) in the reference picture and the phase (⊖x, ⊖y) are determined (810) from the block position (XCur, YCur) in the current picture and the motion vector (MVx,MVy) of the current block. According to an embodiment, horizontal filtering (illustrated on FIG. 9) with 1D filter is performed (820, 940) to determine the motion-compensated samples upscaled along the horizontal direction.

In an embodiment, since the motion vectors have sub-pel precision, there are as many 1D filters as the number of sub-pel position (phase). FIG. 7 depicts how the coefficients w(i) of the filters are determined depending on the phase of the motion-compensated sample Xcur. The reconstructed sample “rec” is computed with 1D filtering as:

$$rec = {\sum }_{i = - N}^{N} w ( i ) \cdot x ( Xref + i ) \qquad ( eq . 2 )$$

The reconstructed samples are stored (830) into a temporary buffer (930 in FIG. 9) of a same size (SXcur, SYref). Then, vertical filtering is performed (840) with 1D filter, as illustrated in FIG. 10 using the temporary buffer as input to determine the motion-compensated samples upscaled along the vertical direction.

Note that one can also do first Vertical and next Horizontal filtering, since they are separate filters.

The resulting predicted samples are stored (850) into a block (1050) of size (SXcur, SYcur).

In the description above, one considered that the current picture and the reference picture correspond to the same window. It means that if the motion is zero, then the top left and bottom right samples of the two pictures correspond to the two same scene points. If this is not the case, one should add an offset window parameter to (Xref, Yref).

The motion-compensation with implicit resampling described above allows to re-use interpolation filters designed for classical motion-compensation, e.g. the interpolation filters used in the VVC standard. Also, this process avoids the necessity to store reference pictures at several resolutions. However, the simplicity of the up-sampling filters limits the compression efficiency of the encoder. Thus, there is a need for improvement.

In an embodiment, a method for reconstructing at least one part of a first picture, from at least one part of a second picture is provided, wherein the first picture and the second picture having different sizes. For instance, the second picture has a smaller resolution than the first picture.

According to this embodiment, reconstructing the part of the first picture comprises decoding the second picture from a bitstream, and determining at least one first sample of said at least one part of the first picture using at least one upsampling filter applied to at least one second sample of said at least one part of the decoded second picture.

In an embodiment, the method for reconstructing comprises transmitting said at least one reconstructed part of the first picture to a display. In an embodiment, the steps of the reconstructing method provided below can be implemented in the method for decoding (510, 540) described in reference with FIG. 5.

According to an embodiment, the method for reconstructing can be implement in an encoding method or a decoding method. The at least one part of the first picture is obtained from decoding the second picture and upsampling the at least one part of the second picture as described below. The reconstructed at least one part of the first picture is then stored in a decoded picture buffer for future use as a reference pictures when coding/decoding subsequent pictures of a same size or a different size as the first picture.

In the following some embodiments are provided wherein filter parameters are determined. The filter parameters comprise the upsampling filter coefficients, the associated tap locations (shape), and possibly an index to identify the filter. Any one of the embodiments provided below can be implemented alone or in combination with any one or more of the others embodiments, in the method for reconstructing a picture, the method for encoding, and/or the method for decoding provided above.

According to an embodiment, the up-sampling filter is not separable. In this embodiment, the upsampling filter cannot be handled through a two-step up-sampling with 1D filters. The filters may be linear or non-linear.

According to another embodiment, the up-sampling filter coefficients are coded in the bitstream. In a variant, the up-sampling filter coefficients can be coded even if the reference and the current pictures have same size. In the bitstream, size of the original picture (after up-sampling) is coded. The size of the original picture can be a parameter associated with the up-sampling filter. The up-sampling filter coefficients and/or original size may be coded in the APS (Adaptation Parameter Set, used in the VVC standard for transmitting the Adaptive Loop Filter coefficients for instance), slice header, picture header or PPS for example. There may have default values of up-sampling filter coefficients which are not coded in the bitstream.

The filter(s) coefficients may be derived per picture, per region in one picture, per group of several pictures or several regions in different pictures.

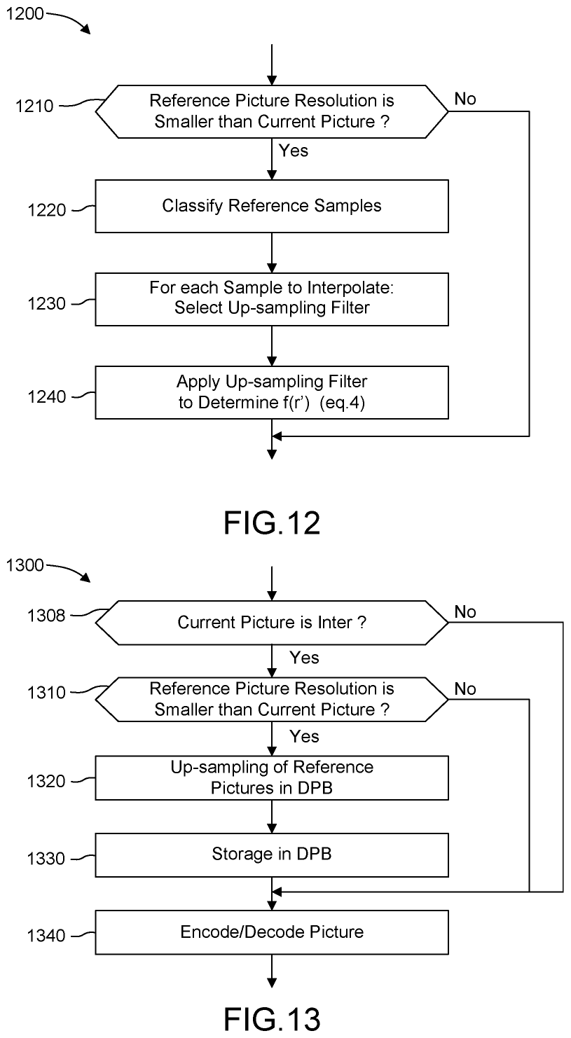

FIG. 12 illustrates an example of a method 1200 for determining an upsampling filer according to an embodiment. Several up-sampling filters can be available. The choice of the up-sampling filter to use may be controlled by a classification process.

According to a variant, when the upsampling is in-loop of the motion compensation for predicting a current picture, the upsampling of the reference picture to be used by the current picture is performed responsive to a determination that (1210) the reference picture resolution is smaller than current picture.

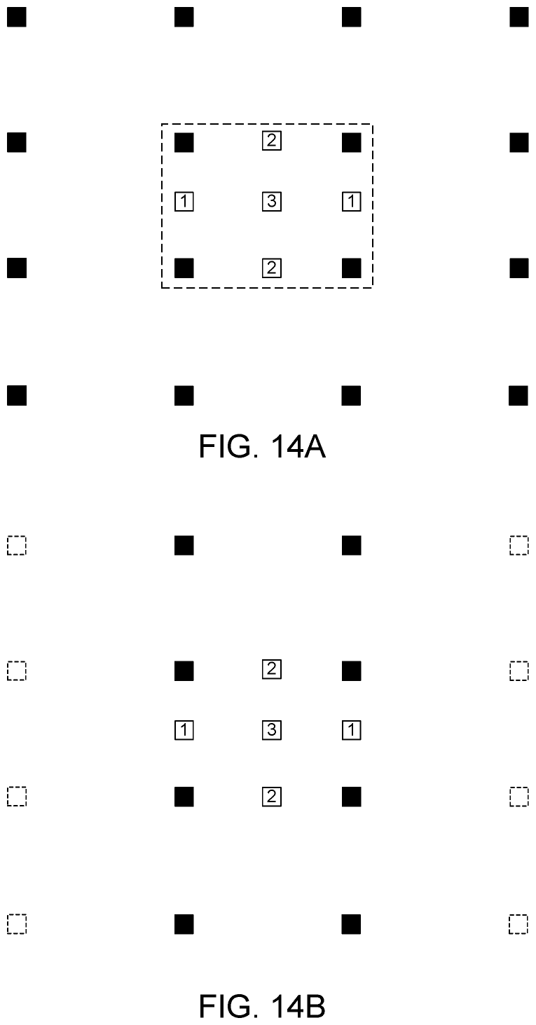

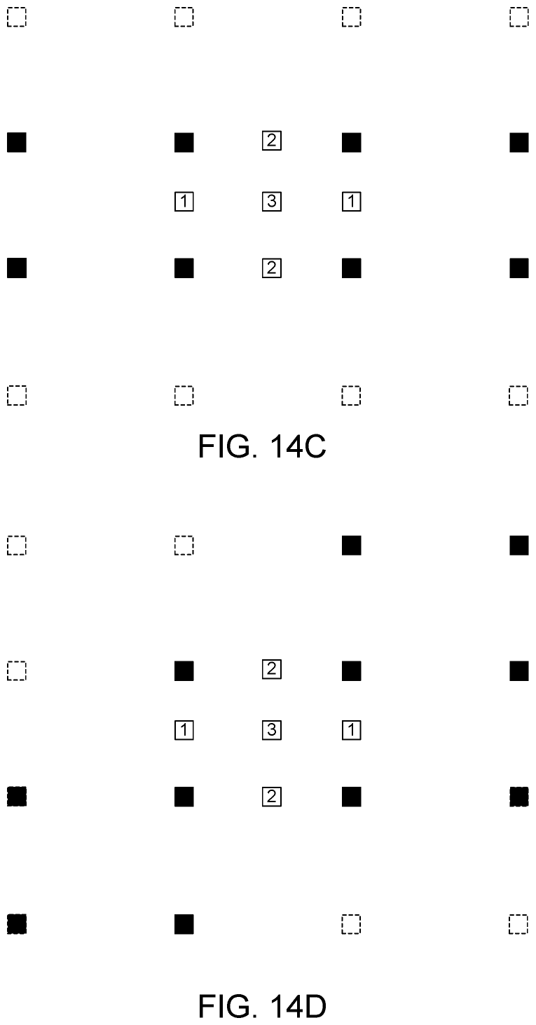

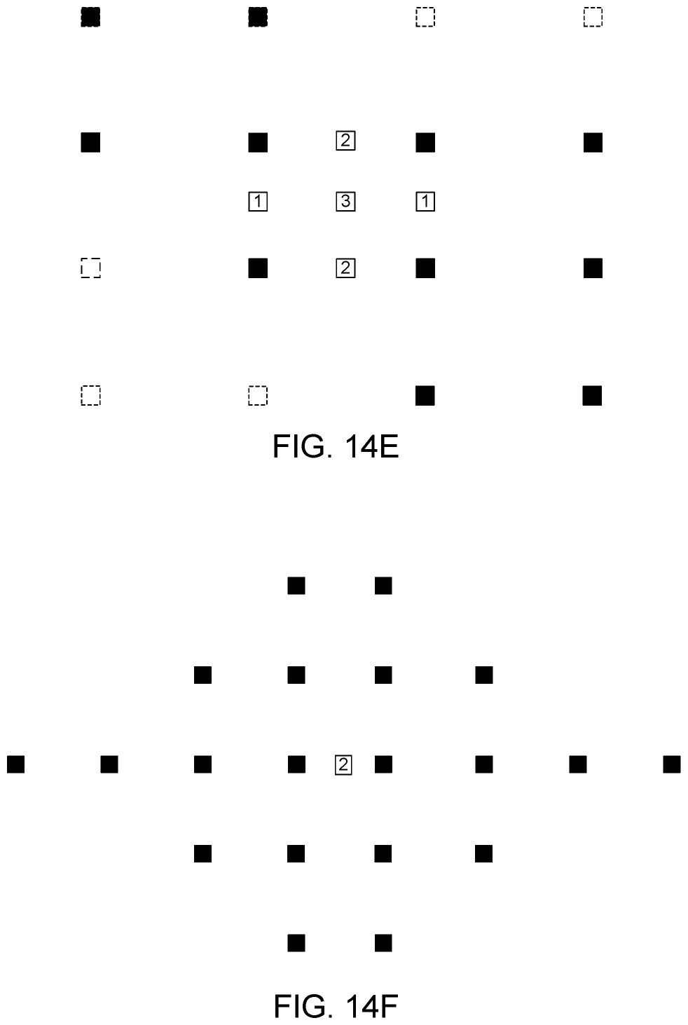

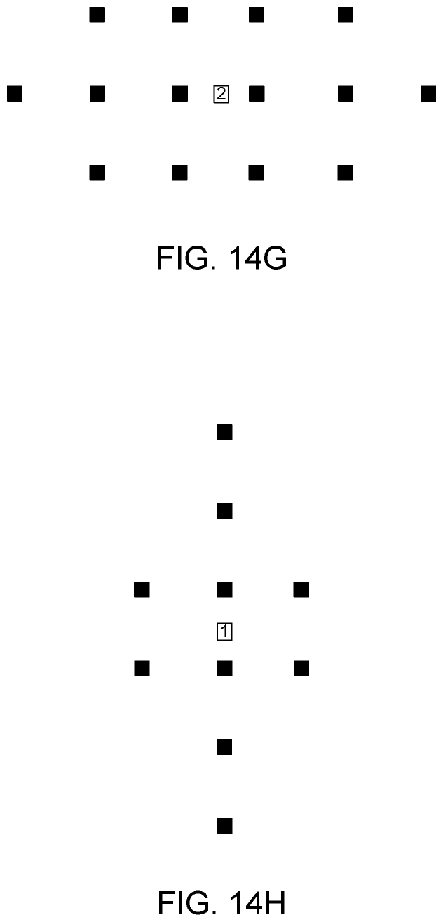

The classification process determines (1220) a class index for each reference sample or group of reference samples (for instance a group of 4×4 samples). One filter is associated with one class index. In the example of FIG. 14A, showing a region to interpolate, black samples illustrate reference samples for which a class index has been determined, and example of samples to be interpolated (1,2,3).

For each sample to interpolate in the up-sampled picture, a set of corresponding co-located reference samples is determined. For instance, FIG. 14A shows examples of co-located reference samples (black samples in the dashed box) associated with the sample 3 to be interpolated. The class indexes associated to the co-located reference samples of the sample to interpolate allow to derive one single class index value for the sample to interpolate. For example, it can be the class index value of the closest co-located reference sample with the current sample to interpolate, or at a pre-determined relative position or an average/median of the class index values of several co-located reference samples.

For each sample to interpolate, an upsampling filter is selected (1230) based on the class index derived for the sample to interpolate. Since the classification is performed on the reference samples of the reference picture to upsample or the decoded picture in case of an upsampling for display, the class index value used to determine the upsampling filter for each sample to interpolate does not need to be coded.

The upsampling filter is then applied (1240) to determine the value of the sample to interpolate. According to embodiment, the classification process (1220) can be similar as the one used in the Adaptive Loop Filter (ALF) in the VVC standard. The reconstructed samples “t(r)” are classified into K classes (K=25 for luma samples, K=8 for chroma samples) and K different filters are determined with the samples of each class. The classification is made with Directionality and Activity values derived with local gradients.

The above method 1200 can be applied for instance when the picture is encoded in a downscaled version, decoded in the downscaled version and upsampled for output, for instance for transmission to a display.

According to another embodiment, the method 1200 can also be used for determining a downsampling filter that can be used for downsampling a picture. For instance, the downsampling of the picture can be performed prior to its encoding when the picture is to be encoded in the downscaled version.

FIG. 13 illustrates an example of a method for encoding/decoding a picture according to an embodiment. According to this embodiment, it is determined whether the current picture is to be coded or decoded using inter-prediction (1305).

When the current picture is not coded/decoded using inter-prediction, the picture is coded/decoded (1340), for instance using intra-prediction.

When the current picture is coded/decoded using inter-prediction, it is determined whether the reference picture resolution is smaller than the resolution of the current picture (1310). If no, the current picture is coded/decoded using the reference pictures stored in the DPB (1340). When the reference picture has a larger size than the current picture, the down-scaling is carried out with the regular RPR (Reference Picture Resampling) motion interpolation process from the VVC standard when encoding/decoding the current picture.

When the reference picture has a smaller size than the current picture (1310), the up-scaling (1320) is carried out with up-sampling filter(s) determined according to any one of the embodiments proposed herein. The up-sampling with filter(s) may be done on-the-fly within the motion compensation process when encoding/decoding the current picture (1340) or the reference pictures of the DPB may be up-scaled (1320) before coding/decoding the current frame (1340) and stored in the DPB (1330).

In this last case, the DPB may contain several instances of reference pictures at different resolutions and the motion compensation is unchanged compared to encode/decode without RPR (1340).

According to an embodiment, the up-sampling filter is a Wiener-based adaptive filter (WF). For instance, the coefficients are determined in a similar manner as the coefficients of ALF in the VVC standard.

In VVC, the in-loop ALF filter (adaptive loop filtering) is a linear filter whose purpose is to reduce coding artefacts on the reconstructed samples. The coefficients cₙ of the filter are determined so that to minimize the mean square error between original samples s(r) and filtered samples t(r) by using Wiener-based adaptive filter technique.

$$f ( r ) = {\sum }_{n = 0}^{N - 1} {c}_{n} \cdot t ( r + {p}_{n} ) \qquad ( eq . 2 )$$

where:
r=(x,y) is the sample location belonging to the to-be-filtered region “R”.
Original sample: s(r)
To-be-filtered sample: t(r)
FIR filter with N coefficients: c=[c₀, . . . c_{N-1}]

Filter tap position offset: {p₀, p₁, . . . p_{N-1}}, where pₙ denotes the sample location offset to r of the n^{th} filter tap. The set of tap positions can also be named the filter “shape”.
Filtered sample: f(r)

To find the minimum sum of squared errors (SSE) between s(r) and f(r), the derivatives of SSE with respect to cₙ can be determined and let the derivatives equal to zero. Then the coefficient values “c” are obtained by solving the following equation:

$$[ Tc ] \cdot {c}^{T} = {v}^{T} \qquad ( eq . 3 )$$

where:

$$[ Tc ] = [ \begin{matrix}{\sum }_{R} t ( r + {p}_{0} ) \cdot t ( r + {p}_{0} ) & {\sum }_{R} t ( r + {p}_{1} ) \cdot t ( r + {p}_{0} ) & … & {\sum }_{R} t ( r + {p}_{N - 1} ) \cdot t ( r + {p}_{0} ) \\ {\sum }_{R} t ( r + {p}_{0} ) \cdot t ( r + {p}_{1} ) & {\sum }_{R} t ( r + {p}_{1} ) \cdot t ( r + {p}_{1} ) & … & {\sum }_{R} t ( r + {p}_{N - 1} ) \cdot t ( r + {p}_{1} ) \\ … & … & … & … \\ {\sum }_{R} t ( r + {p}_{0} ) \cdot t ( r + {p}_{N - 1} ) & {\sum }_{R} t ( r + {p}_{1} ) \cdot t ( r + {p}_{N - 1} ) & … & {\sum }_{R} t ( r + {p}_{N - 1} ) \cdot t ( r + {p}_{N - 1} )\end{matrix} ]$$

$$v = [ \begin{matrix}{\sum }_{R} s ( r ) \cdot t ( r + {p}_{0} ) \\ {\sum }_{R} s ( r ) \cdot t ( r + {p}_{1} ) \\ … \\ {\sum }_{R} s ( r ) \cdot t ( r + {p}_{N - 1} )\end{matrix} ]$$

In VVC, the coefficients of the ALF may be coded in the bitstream so that they can be dynamically adapted to the video content. There are also some default coefficients and the encoder indicate which set of coefficients to be used per CTU.

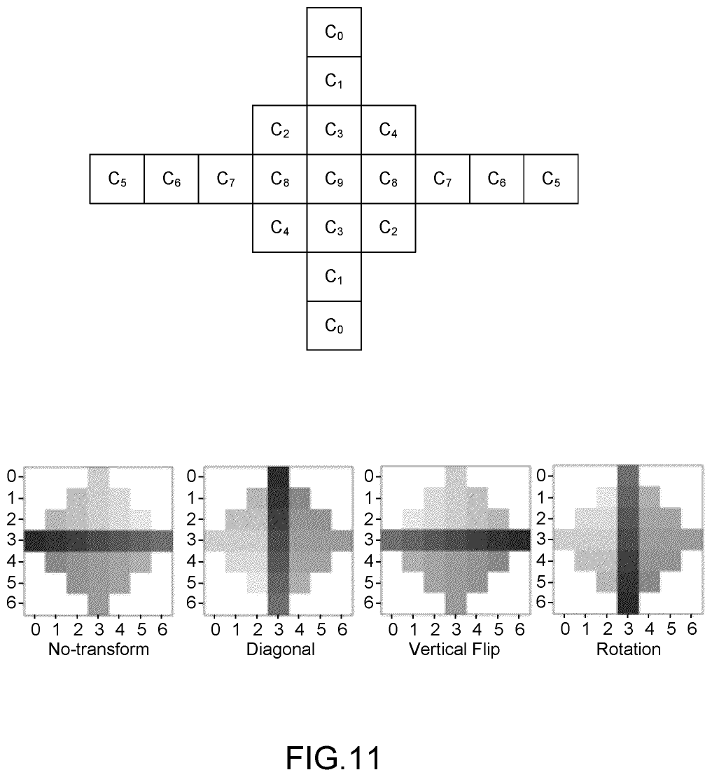

In VVC, symmetrical filters are used, as illustrated in the upper part of FIG. 11 and some filters may be obtained from other filter by rotation, as illustrated on the lower part of FIG. 11. Each coefficient in the filter illustrated on the upper part of FIG. 11 is associated to one or two positions p(x,y). For example, let's denote p9(0,0) and p3(0,−1) or p3(0,1) the positions of c9 and c3. In case of Diagonal transformation, the position p(x,y) is moved to p(y,x), in case of vertical flip transformation, the position p(x,y) is moved to p(−x,y) and in case of rotation the position p(x,y) is moved to p(y,−x).

According to an embodiment, the above method for determining ALF coefficients is used for determining the upsampling filter coefficients.

According to an embodiment, there may have at least one WF per up-sampling phase. The phase of the sample to interpolate allows determining the up-sampling filter to use (1230). The example depicted in FIG. 14A corresponds to an up-sampling by 2 in horizontal and vertical directions. The black points are the reconstructed samples t(r) of the decoded picture (either the reference picture or the decoded picture to upsample for display) and the white points correspond to the to-be-interpolated samples f(r′) (the missing samples). Then “r′” can be different from “r”. In this example, there are 3 phases {0, 1,2,3}. The phase-0 has the same location as the reconstructed samples (r′=r). The WF corresponding to phase-0 may be omitted (inferred to identity).

The (eq.2) is modified as follows (1240):

$$f ( {r}^{′} ) = {\sum }_{n = 0}^{N - 1} {c}_{n} \cdot t ( r + {p}_{n} ) \qquad ( eq . 4 )$$

In the (eq.3), the expression of “v” is modified as follows:

$$v = [ \begin{matrix}{\sum }_{R ′} s ( {r}^{′} ) \cdot t ( r + {p}_{0} ) \\ {\sum }_{R ′} s ( {r}^{′} ) \cdot t ( r + {p}_{1} ) \\ … \\ {\sum }_{R ′} s ( {r}^{′} ) \cdot t ( r + {p}_{N - 1} )\end{matrix} ] \qquad ( eq . 5 )$$

where r′=(x,y) is the sample location belonging to the to-be-interpolated region “R”.

According to a variant, only the missing points r(x,y) in the upscaled picture, i.e. the points that have no-colocated points in the downscaled picture, are interpolated. In another variant, all positions r(x,y) are interpolated, i.e. the missing points and the points that have a co-located point in the downscaled picture, are interpolated.

In a variant, some samples corresponding to some subsets of phases are interpolated with the WF filter only, whereas other phases are interpolated with regular separable 1D filters. For example, in the FIG. 14A, phases 0 and 1 are interpolated with WF in a first step and next phases 2,3 are interpolated with horizontal 1D filter using filtered samples of phases 0 and 1. Or conversely, phases 0 and 2 are interpolated with WF and next phases 1,3 are interpolated with 1D vertical filter.

In FIG. 14A, a square filter shape of size 4×4 is shown, but it may have different shapes. FIG. 14B-E illustrates different shapes that can be used for interpolating the sample with phase 3, the filter shape being illustrated by the black samples which represent the reconstructed samples to use for interpolating the sample with phase 3.

FIGS. 14F and 14G illustrates other examples of horizontal filter shapes that can be used for interpolating the sample with phase 2. FIG. 14H illustrates another example of a vertical filter shape that can be used for interpolating the sample with phase 1. FIG. 14I illustrates another example of a central filter shape that can be used for interpolating the sample with phase 3.

The shape may depend on the class and/or on the phase. Similarly to ALF, the coefficients of some shapes/class may be identical to other class/shape but obtained by rotation and the coefficients of one shape may be obtained by symmetry. For example, the coefficients of the shape of FIG. 14B may be the same as the shape of FIG. 14C after 90º rotation.

In a variant, a classification of the reference samples is made (1220). For each class, a different up-sampling WF is used. In another variant, the classification can be the same as the one used by ALF.

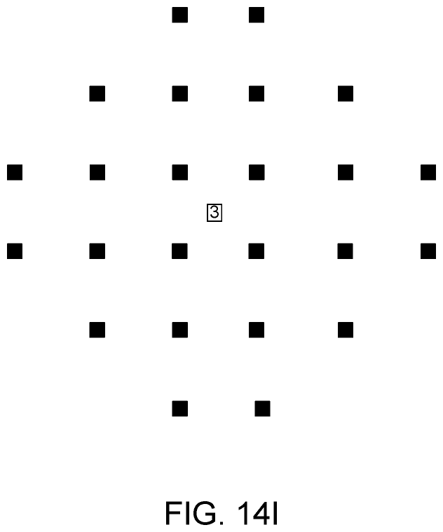

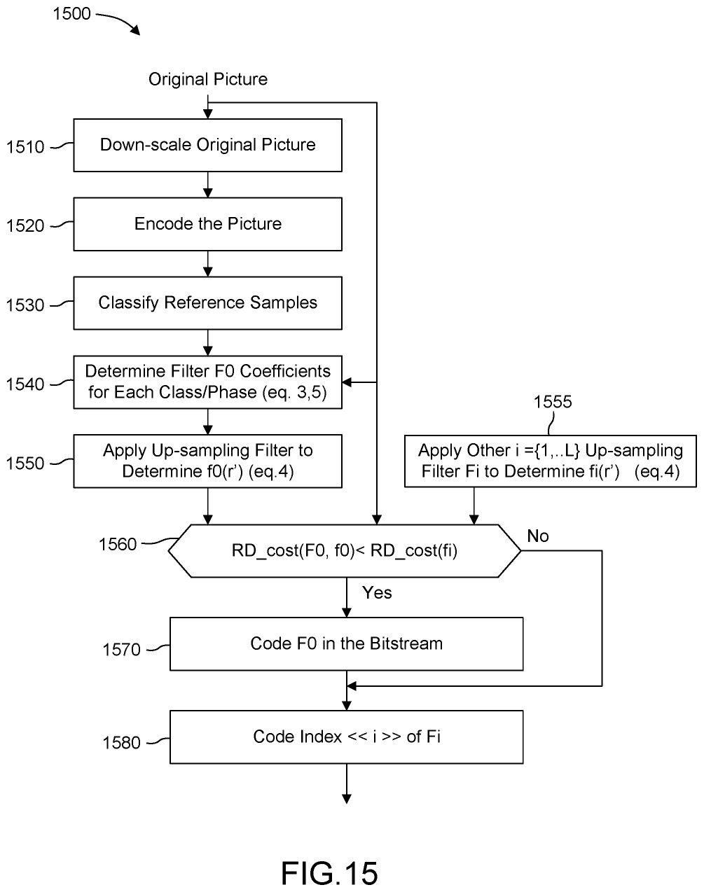

FIG. 15 illustrates an example of a method 1500 for determining upsampling filter coefficients to use at the encoder side, according to an embodiment.

The original picture is down-scaled (1510) and encoded (1520). The reconstructed samples from the coded picture are classified per class (1530). A set of filter coefficients F0 is determined (1540) for a region R of the reconstructed picture, for instance for a CTU or a group of CTUs. The set of filter coefficients F0 comprises an upsampling filter for each class and phase with F0={g₀₀, g₀₁, . . . , g_{0M}}where M is the number of classes or phases or the number of combination of classes and phases, in case there is one filter associated per each class and phase. The filters of the set F0 are determined with (eq.3, eq.5) as explained above.

The determined upsampling filters F0 are applied (1550) to obtain the samples f0(r′) of the upsampled region Rup of the region R of the reconstructed picture, using eq. 4.

Other upsampling filters Fi are similarly applied (1555) to determine the samples fi(r′) of the upsampled region Rup of the region R of the reconstructed picture, with Fi={gi0, gᵢ₁, . . . , g_{iM}} and i={1, . . . L} where L is the number of possible filters for each class and or phase already transmitted or known by the decoder. Advantageously, the distortion may be derived directly from the values of the coefficients and the original samples s(r′).

The choice of the filter to be used for a class/phase may be determined by finding the best trade-off (1560), for instance using a rate-distortion Lagrangian cost, between coding the new up-sampling filter g₀ₛ or re-use default or previously transmitted filter values gᵢₛ, i={1, . . . . L} for each class/phase s. The distortion is the difference (ex: L1 or L2 norm) between the up-sampled reconstructed region and the corresponding region in the original picture.

If the rate-distortion cost of the determined filter g₀ₛ for the class/phase s is lower than any one of the rate distortion cost of the filters gᵢₛ, then the coefficients of the filter g₀ₛ are coded (1570) in the bitstream.

For each class/phase s, the index I, with i=0 . . . . L, of the filter that provides the lowest rate distortion cost is coded (1580) in the bitstream for the region R.

In some embodiments, the region R can be a region in the reconstructed picture, the whole picture, a group of several pictures or a group of several regions in different pictures.

The method for determining the filter to use for a region R is described above in the case wherein there is one filter per class and/or phase. A similar method can be applied in the case where F0 and Fi comprises respectively one single filter.

In a variant, the determination of the filter coefficients may be done with machine learning using iterative optimization algorithm (ex: with gradient descent). This may have the advantage to learn on a lot of samples/images without numerical limitations of Tc and v when R is large.

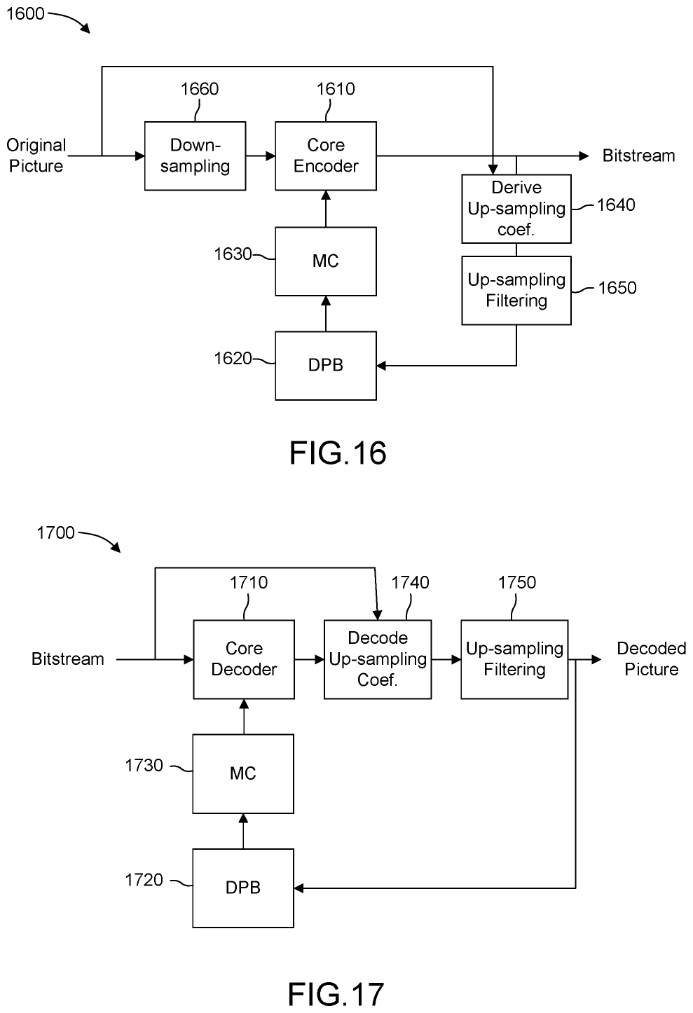

According to an embodiment, the reconstructed up-sampled pictures are stored in the DPB even if the coded pictures correspond to the down-sampled pictures as depicted in FIG. 16 and FIG. 17. According to this embodiment, the DPB comprises the reference pictures at the high-resolution only.

FIG. 16 and FIG. 17 respectively illustrate a method 1600 for encoding a video, respectively a method 1700 for decoding a video, according to an embodiment. The original pictures can be coded in a lower resolution or the high resolution.

The original high-resolution pictures are down-sampled (1660) by the encoder before coding (1610). The up-sampling filter(s) coefficients may be derived (1640) as described above and the reconstructed pictures are up-sampled (1650) before storage in DPB (1620). Then the regular RPR motion compensation is applied (reference picture is high-resolution, current picture is low-resolution) (1630).

At the decoding stage, the downscaled pictures are decoded from the bitstream (1710) and the upsampling filter coefficients are decoded (1740) if present in the bitstream. The low-resolution decoded pictures are up-sampled (1750) and stored in DPB (1720). Then the regular RPR motion compensation is applied (reference picture is high-resolution, current picture is low-resolution) (1730). In a variant, the low-resolution decoded pictures are stored in the DPB and the up-sampled decoded pictures are used for display only.

If the original picture is coded at the high resolution, the down-sampling (1660) and up-sampling (1650, 1750) are by-passed.

Note that, in a variant, the up-sampling filter(s) have pre-determined default coefficients and steps 1640 and 1740 are not present/by-passed.

### Post-Filtering for Image Restoration

In video standards (e.g. HEVC, VVC), restoration filters are applied on the reconstructed pictures to reduce the coding artifacts. For example, the Sample Adaptive Offset (SAO) filter has been introduced in HEVC to reduce ringing and banding artefacts in the reconstructed pictures, in complement to the De-Blocking Filter (DBF) which reduces artifacts at block boundaries specifically. In VVC, an additional Adaptive Loop Filter (ALF) tries to minimize the mean square error between original samples and reconstructed samples using Wiener-based adaptive filter coefficients. SAO and ALF employ classification of the reconstructed samples to select the filter to apply.

### ALF Classification

As discussed above, ALF is a particular post-filter for reconstructed images restoration. ALF classifies the samples into K classes (as an example: K=25 for luma samples) or K regions (as an example: K=8 for chroma samples) and K different filters are determined with the samples of each class or regions. In case of classes, the classification of luma samples is made with Directionality and Activity values derived with local gradients.

In VVC, the coefficients of the ALF may be coded in the bitstream so that they can be dynamically adapted to the video content. These coefficients may be stored to be re-used for further pictures. There are also some default coefficients, and the encoder indicates which set of coefficients to be used per CTU.

In VVC, symmetrical filters are used (as illustrated on the top part of FIG. 11) and some filters coefficients may be obtained from other filter coefficients by rotation (as illustrated on the bottom part of FIG. 11).

### Motion Compensation Filtering and SIF

In hybrid video coding, the inter prediction predicts the current block with motion compensation of a reference block extracted from a previously reconstructed reference picture. The difference of position between the current block and the reference block is the motion vector.

The motion vectors may have sub-pel precision (ex: 1/16 in VVC) and the motion compensation process selects the interpolation filter with the corresponding sub-pel position in the reference picture (θₓ, θ_{y}) as depicted in FIG. 6. Traditionally, to reduce implementation complexity, the motion compensation interpolation filtering is carried out with separable filters: one horizontal and one vertical.

To improve coding efficiency, for some sub-pel positions, the encoder may select among several filters and signal it in the bitstream. For example, in the VVC standard, for ½ sub-pel position, one may choose between two interpolation filters (regular or gaussian filter). Such a tool is also known as Switching Interpolation Filter (SIF tool). The gaussian filter is a low-pass filter that smoothes the high frequencies compared to the regular filter.

According to the ALF post-filtering, better efficiency in the filtering process is obtained when the samples (or group of samples) to be filtered are pre-classified and the classification is used to select one specific filter coefficient set for each sample (or group of samples). At the encoder side, the classification may be used to determine the coefficients of the filter that minimize the mean square error between original samples “s(r)” and filtered samples “t(r)” by using Wiener-based adaptive filter technique (as described for example in C. Tsai et al. “Adaptive Loop Filtering for Video Coding,” IEEE JOURNAL OF SELECTED TOPICS IN SIGNAL PROCESSING, VOL. 7, NO. 6, December 2013.)

However, classification of the samples significantly increases the number of operations per sample.

In VVC, only ALF uses classification. The SIF tool signals per CU which filter to be used for motion compensation, but the same filter is used for building all the prediction samples of the prediction unit. For RPR, one single set of re-scaling interpolation filter is selected per picture with the ratio between the reference and the current block size and all the samples are filtered with this single filter. A set of re-scaling filter contains for each phase the coefficients of the filter to be used.

According to an aspect of the present principles, a method for encoding/decoding a video is provided wherein sample classification of a reference picture is used for selecting at least one motion compensation interpolation filter when predicting a block of a picture of the video.

According to an embodiment, for each sample or group of samples from the reference picture that need to be interpolated, it is determined a class to which the sample belongs (from the classification performed on the reference picture). Then, an interpolation filter associated to this class is selected and the sample is filtered using the coefficients of the selected filter.

According to another aspect of the present principles, a method for encoding/decoding a video is provided wherein sample classification of a reconstructed picture is shared among different encoding/decoding modules of the encoder/decoder. For instance, a reference picture is classified, and the classification is then used for selecting at least one filter that is used during an encoding/decoding operation of a new picture using the reference picture, such as re-sampling filtering, or a motion-compensation interpolation filtering.

According to another example, a reconstructed picture is classified, and the classification is then used for selecting at least one filter that is used during an encoding/decoding operation on the reconstructed picture such as post-filtering, and/or resampling for display, and/or during an encoding/decoding operation of a new picture using the reconstructed picture as a reference picture, such as re-sampling filtering, or a motion-compensation interpolation filtering. For example, this can be carried out for each sample (or group of samples), the sample (or group of samples) classification allowing selecting the filter to be used with this sample (or group of samples).

Classically, a filter comprises several coefficients, each coefficient being applied to a neighbor sample of the current sample that is being filtered, the neighbor samples being determined according to the selected filter shape, an example of filter shapes is given in FIG. 11.

According to an embodiment, for sharing the classification between any encoding/decoding modules, the result of the classification is stored in a common space accessible by any one of the encoding/decoding modules, such as the decoded picture buffer (DPB) storing the reference pictures.

According to the present principles, the power of sample classification for filter selection is leveraged to the motion compensation interpolation filters and the re-sampling filters, while keeping the complexity relatively small. This is done by sharing the sample classification for several filtering purposes: restoration filters (ex: ALF or bilateral filter), MC filtering, re-sampling filters. In an embodiment, the classification may be stored in the DPB.

At the encoder, the classification of the reconstructed samples allows deriving specialized filters for each class of samples. This can be done by minimizing the mean square error between original samples and reconstructed samples belonging to one class, using Wiener-based adaptive filter coefficients for example.

Next, at the decoder side, the choice of the filter to use is controlled by the classification process. For example, the classification process determines a class index for each sample and one filter is associated with one class index.

In some variants, the classification is made per group of samples rather than per sample. For example, the group of samples is 2×2 region.

### Classification for Interpolation Filters

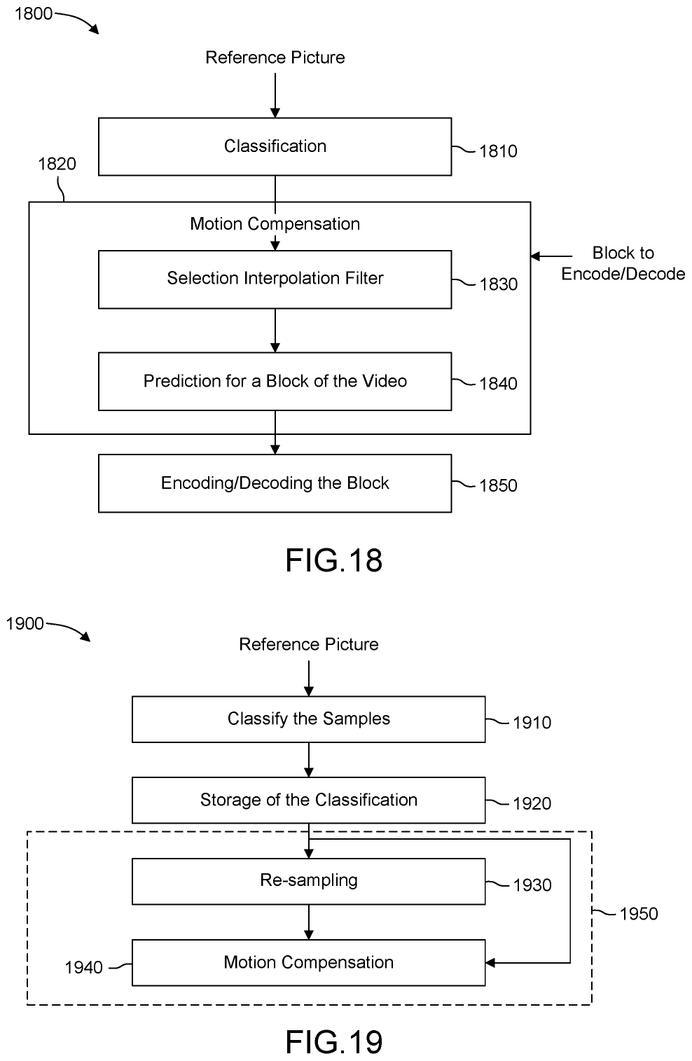

FIG. 18 illustrate a method 1800 for encoding or decoding a video according to an embodiment. According to this embodiment, a set of interpolation filters is defined comprising an interpolation filter for each class index. The interpolation filters can be determined in a same manner as for the ALF filters and coefficients of a new interpolation filter can be transmitted to the decoder when necessary to adapt with the content.

A reference picture is input to the process. Samples of the reference picture are classified (1810). Then, at 1820, motion-compensation of the block is performed for determining a prediction for a current block to encode or to decode.

For a block of the video to encode or to decode, a motion vector is obtained. The motion vector allows determining a part or a block of the reference picture for predicting the block.

When the motion vector points to sub-sample locations, as illustrated on FIG. 6, the samples of the motion-compensated part of the reference picture have to be interpolated to determine the block samples for the prediction. According to the present principles, the interpolation filter used for each sub-sample is determined based on the classification (1830).

A prediction for the block is thus determined (1840) as the interpolated samples of the reference picture.

According to an embodiment, for determining the interpolation filter (1830), for each sample of the motion-compensated part of the reference picture, a class index is determined, for instance from one or more class index associated with one or more neighboring samples at sample location in the reference picture. An interpolation filter is then selected for each sub-sample to interpolate using the class index determined for the sub-sample. Prediction of the block is then generated (1840) by interpolating each sub sample of the motion-compensated part of the reference picture with the interpolation filter selected for this sub sample. Finally, the block is encoded or decoded (depending on whether the method is implemented at the encoder or at the decoder) using the prediction (1850). At encoding, a residue is determined between the original block and its prediction, and coded. At decoding, the residue is decoded and added to the prediction for reconstructing the block, the prediction of the block being generated with the same process as for the encoder.

According to another aspect of the present principles, a same sample classification is shared between encoding/decoding modules of the encoder or decoder. A set of filters is defined for each kind of encoding or decoding operations using a filter, such as motion compensation interpolation, re-sampling, ALF.

### Same Classification for Interpolation and Re-Sampling Filters

FIG. 19 illustrates an example of a method 1800 for encoding or decoding a video according to another embodiment. To leverage the power of sample classification for filter selection for both the motion compensation (MC) interpolation (1940) filters and the re-sampling (1930) filters, one can perform and use a common classification of a reference picture (19810).

Advantageously, the classification is made for the whole reconstructed picture and the classification of each sample is stored (1920) so that it can be used by the motion compensation interpolation filters and the re-sampling filters processes. In case the re-sampling is implicitly done within the MC process (1950), the classification is input to the MC directly.

According to an embodiment, the classification is stored in the DPB with the reference pictures so that it can be re-used by other processes.

### Same Classification for Interpolation, Re-Sampling Filters and Post-Filtering

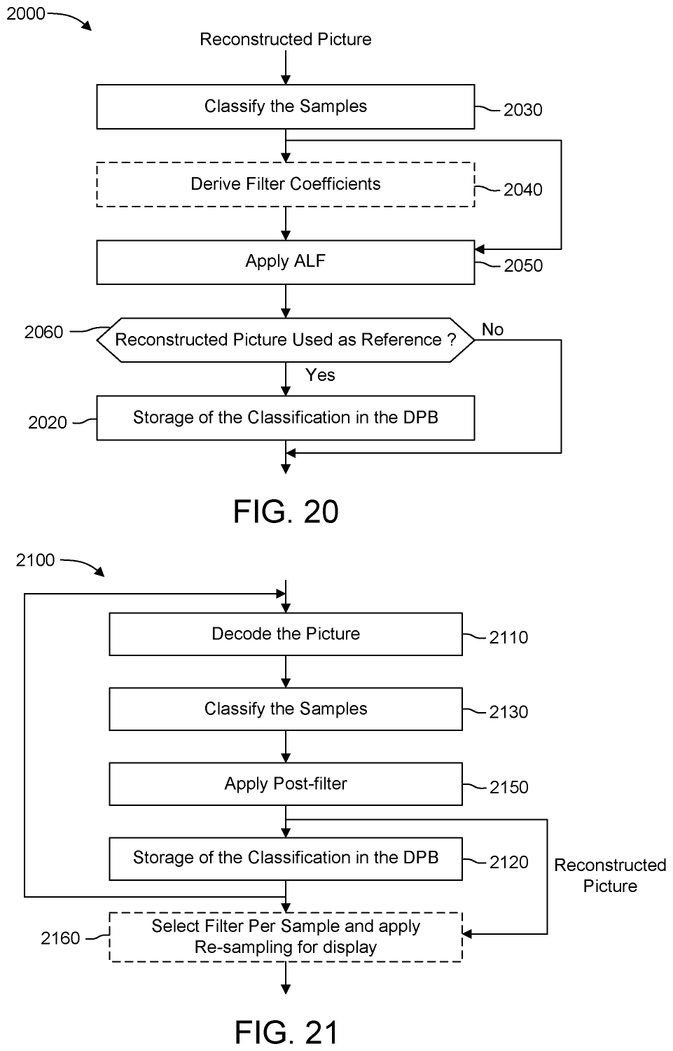

FIG. 20 illustrates an example of a method 2000 for encoding or decoding a video according to another embodiment. In this variant, the classification (2030) is performed on the reconstructed pictures before applying restoration filter (a.k.a post-filters, PF)(ex: ALF)(2050). Then the classification may be used by the encoder to derive filter coefficients of post-filters (ex/ALF) (2040). The classification is used to select the filters to be used by the post-filtering (2050). Advantageously, this classification is also used by the re-sampling filtering or motion compensation interpolation filtering so that only one single classification stage (2030) is carried out. Note that in this variant, the other processes (ex: re-sampling filtering or motion compensation interpolation filtering) use a classification that is done before applying the restoration filters (post-filtering), whereas the other processes use the restored pictures samples (after applying post-filtering).

According to embodiment, the classification may be stored in the DPB (2020) so that it can be re-used by other processes. In a variant, the storage in the DPB is done if the picture is used as reference only (2060).

### Out-of-Loop Re-Sampling

In case of RPR, the re-sampling process of the decoded pictures may be unspecified (FIG. 5: 540). FIG. 21 illustrates an example of a method 2100 for decoding a video according to another embodiment. The picture is decoded (2110) and samples of the decoded picture are classified (2130). Post-filters are applied (2150) based on the classification and the classification is eventually stored in the DPB so that it is available for other processes using the decoded picture as reference picture.

The choice of the re-sampling filter (ex: up-sampling) to use may be controlled by the classification process (2130). The classification process determines a class index for each sample (or group of samples) and one filter is associated with one class index. The filter index allows selecting the re-sampling filter (2160).

It is to be understood that the encoding, respectively decoding, methods described above can be implemented in the encoder 200, respectively decoder 300 described in relation with FIGS. 2 and 3 for encoding, respectively decoding a video in/from a bitstream.

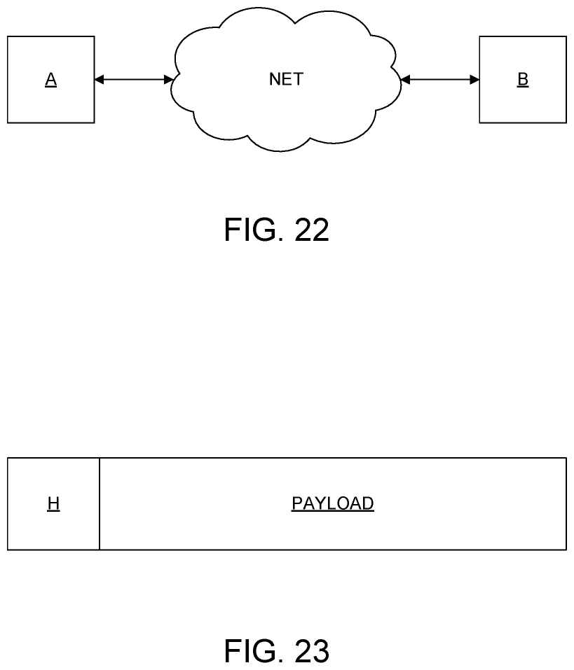

In an embodiment, illustrated in FIG. 22, in a transmission context between two remote devices A and B over a communication network NET, the device A comprises a processor in relation with memory RAM and ROM which are configured to implement a method for encoding a video according to any one of the embodiments described with FIG. 1-21 and the device B comprises a processor in relation with memory RAM and ROM which are configured to implement a method for decoding a video according to any one of the embodiment described in relation with FIGS. 1-21.

In accordance with an example, the network is a broadcast network, adapted to broadcast/transmit encoded data representative of a video from device A to decoding devices including the device B.

A signal, intended to be transmitted by the device A, carries at least one bitstream comprising coded data representative of a video. The bitstream may be generated from any embodiments of the present principles.

FIG. 23 shows an example of the syntax of such a signal transmitted over a packet-based transmission protocol. Each transmitted packet P comprises a header H and a payload PAYLOAD. In some embodiments, the payload PAYLOAD may comprise coded video data encoded according to any one of the embodiments described above. In some embodiments, the signal comprises the filter (upsampling, interpolation) coefficients as determined above.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode upsampling filter coefficients, upsampling a decoded picture.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining upsampling filter coefficients, upsampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of upsampling filter coefficients. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Encoding/decoding a video wherein the original picture can be encoded at a high-resolution, or a lower-resolution, according to any of the embodiments described.
Reconstructing a picture from a downscaled decoded picture, according to any of the embodiments described.
A bitstream or signal that includes one or more of the described syntax elements, or variations thereof.
A bitstream or signal that includes syntax conveying information generated according to any of the embodiments described.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs reconstruction of a picture with upsampling according to any of the embodiments described.
A TV, set-top box, cell phone, tablet, or other electronic device that performs reconstruction of a picture with upsampling according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs reconstruction of a picture with upsampling according to any of the embodiments described.
A TV, set-top box, cell phone, tablet, or other electronic device that receives (e.g. using an antenna) a signal over the air that includes an encoded image, and performs reconstruction of a picture with upsampling according to any of the embodiments described.
Encoding/decoding a video wherein a same classification of a picture is shared among encoding or decoding processes, according to any of the embodiments described.
Encoding/decoding a video wherein a classification is used for selecting interpolation filters when sub sample is to be interpolated, according to any of the embodiments described.
A bitstream or signal that includes one or more of the described syntax elements, or variations thereof.
A bitstream or signal that includes syntax conveying information generated according to any of the embodiments described.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs reconstruction of a picture according to any of the embodiments described.
A TV, set-top box, cell phone, tablet, or other electronic device that performs reconstruction of a picture according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs reconstruction of a picture according to any of the embodiments described.
A TV, set-top box, cell phone, tablet, or other electronic device that receives (e.g. using an antenna) a signal over the air that includes an encoded image, and performs reconstruction of a picture according to any of the embodiments described.

1-31. (canceled)

32. A method comprising:
decoding a first picture,
resampling at least one part of the first picture to reconstruct at least one part of a second picture, wherein resampling the at least one part of the first picture comprises, for at least one sample of the at least one part of the second picture, selecting a resampling filter responsive to a sub-pixel position of the sample in the at least one part of the first picture and a classification of the first picture.

33. The method of claim 32, further comprising transmitting the at least one reconstructed part of the second picture to a display.

34. The method of claim 32, further comprising storing the at least one reconstructed part of the second picture in a decoded picture buffer storing reference pictures.

35. The method of claim 33, further comprising encoding a third picture comprising determining a prediction for at least one block of the third picture using the at least one reconstructed part of the second picture and encoding the at least one block of the third picture using the prediction.

36. The method of claim 34, further comprising decoding a third picture comprising determining a prediction for at least one block of the third picture using the at least one reconstructed part of the second picture and decoding the at least one block of the third picture using the prediction.

37. The method of claim 32, wherein the resampling filter is a non-separable filter.

38. The method of claim 32, further comprising:
classifying samples of the at least one part of the first picture,
determining a class index for the at least one sample of the at least one part of the second picture from at least one class index associated to at least one neighboring sample in the at least one part of the first picture,
the resampling filter being selected using the determined class index associated to the at least one sample.

39. The method of claim 38, wherein a different resampling filter is associated to each class.

40. The method of claim 32, wherein the resampling filter is determined based on a rate-distortion cost determined between the at least one part of the second picture and the at least one reconstructed part of the second picture obtained from the decoded first picture.

41. An apparatus, comprising one or more processors, wherein the one or more processors are configured to:
decode a first picture,
resampling at least one part of the first picture to at least one part of a second picture, wherein resampling the at least one part of the first picture comprises, for at least one sample of the at least one part of the second picture, selecting a resampling filter responsive to a sub-pixel position of the sample in the at least one part of the first picture and a classification of the first picture.

42. The apparatus of claim 41, wherein the one or more processors are further configured to store the at least one reconstructed part of the second picture in a decoded picture buffer storing reference pictures.

43. The apparatus of claim 41, wherein the one or more processors are further configured to encode a third picture by determining a prediction for at least one block of the third picture using the at least one reconstructed part of the second picture and coding the at least one block of the third picture using the prediction.

44. The apparatus of claim 41, wherein the one or more processors are further configured to decode a third picture by determining a prediction for at least one block of the third picture using the at least one reconstructed part of the second picture and decoding the at least one block of the third picture using the prediction.

45. The apparatus of claim 41, wherein the one or more processors are further configured to decode coefficients of the resampling filter from a bitstream.

46. The apparatus of claim 41, wherein the one or more processors are further configured to:
classify samples of the at least one part of the first picture,
determine a class index for the at least one sample of the at least one part of the second picture from at least one class index associated to at least one neighboring sample in the at least one part of the first picture,
the resampling filter being selected using the determined class index associated to the at least one sample.

47. A computer readable storage medium having stored thereon instructions for causing one or more processors to perform the method of claim 32.

48. The apparatus of claim 41, further comprising at least one of (i) an antenna configured to receive a signal, the signal including data representative of a video, (ii) a band limiter configured to limit the received signal to a band of frequencies that includes the data representative of video, or (iii) a display configured to display the at least one part of the second image.

49. The apparatus according to claim 48, comprising a TV, a cell phone, a tablet or a Set Top Box.
